(19) United States
(12) Patent Application Publication
(10) Pub. No.: US 2005/0037732 A1
(43) Pub. Date: Feb. 17, 2005

(54) Method and apparatus for locking a wireless communication unit to a selected network

(75) Inventor: Michael D. Kotzin, Buffalo Grove, IL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/639,014

(22) Filed: Aug. 12, 2003

(51) Int. Cl. H04M 11/00

(52) U.S. Cl. 455/411; 455/405

(57) ABSTRACT

A locking function or device (136) for a wireless communication unit (102) and corresponding method locks the communication device (102) to a network of a selected service provider such that the communication device (102) is limited to a lower functionality level if used with another service provider. The locking function (136) unlocks or permits the communication device (102) to be unlocked such that the communication device (102) is not limited to the lower functionality level when used with a network other than the selected network when an accrued measure of usage of the communication device (102) reaches a predetermined level. The accrued measure of usage corresponds for example to accrued revenue generated by the communication device (102).

### FIELD OF THE INVENTION

This invention relates in general to wireless communication units, and more specifically to wireless communication systems and methods for locking and unlocking a wireless communication unit to a selected network.

### BACKGROUND OF THE INVENTION

Wireless telecommunications providers often subsidize prospective subscribers' handsets to attract new subscribers. The cost of the handsets, which are complex and sophisticated devices, would otherwise be fully paid by the subscribers. A subsidy lowers the financial entry barrier for new subscribers. Although this is positive for new subscribers, for such a subsidy to be economical for the wireless network operator, there must be a guarantee or some assurance that the subscriber will eventually return or pay for the subsidy. The service provider, for example, might seek a guarantee that the subscriber's wireless access would be provided only by the network operator offering the subsidy. One approach to this problem has been to limit the subscriber's access to services, when using the subsidized handset, to those offered by the particular operator by “locking” the handset to the subsidizer's network.

One such locking mechanism has been developed that is compatible with standards promulgated by Groupe Speciale Mobile (GSM), a European organization responsible for developing wireless telecommunications standards that have been adopted in many countries. (GSM and certain terms it has defined are referred to for purposes of illustration only in this document. The implementation of methods and apparatus according to the present invention does not depend upon this standard and could be used with other telecommunications standards, including those that presently exist or are yet to be developed). Typically, a subscriber signs a contract with a service provider for a term of one or two years. The phone is locked to the provider's network until the expiration of the contract period, at which time the handset can be unlocked. However, users may not wish to commit themselves to a particular service provider for a long period of time. This is particularly true for business users, who normally have high usage charges. Also, users that generate a relatively large amount of revenue for the service provider may find this scheme to be unfair, since this scheme permits the handset to be unlocked only upon contract expiration. A need exists for a more equitable scheme for locking a subscriber unit to particular services.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages in accordance with the present invention.

FIG. 1 is a block diagram of an exemplary wireless communication unit;

FIG. 2 is a flow chart showing an exemplary process for locking the wireless communication unit to a selected network;

FIG. 3 is a flow chart showing an exemplary process for unlocking the wireless communication unit;

FIG. 4 is a block diagram showing an exemplary wireless infrastructure according to a second embodiment;

FIG. 5 is a flow chart showing an exemplary process for sending an unlock communication for unlocking a wireless communication unit according to the second embodiment; and

FIG. 6 is a flow chart showing an exemplary process for unlocking the wireless communication unit of the second embodiment.

### DETAILED DESCRIPTION OF PREFERRED EMBODIMENTS

The present disclosure concerns communications systems that provide services such as voice and data communications services to communications devices or units, often referred to as subscriber devices, such as cellular phones.

More particularly various inventive concepts and principles embodied in a system for unlocking a wireless communication unit are discussed. The wireless communication unit can be any of a variety of wireless communication units, such as a cellular handset or equivalents thereof.

The communication devices that are of particular interest are those that provide or facilitate voice communication services or data or messaging services, such as conventional two way systems and devices, various cellular phone systems including analog and digital cellular, CDMA (code division multiple access) and variants thereof, GSM, GPRS (General Packet Radio System), 2.5 G and 3G systems such as UMTS (Universal Mobile Telecommunication Service) systems, integrated digital enhanced networks, and variants or evolutions thereof. Similarly, the communication systems and devices can include LAN (local area network) systems that employ anyone of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures.

As further discussed below various inventive principles and combinations thereof are advantageously employed to provide a method and apparatus for unlocking a wireless communication unit, thus alleviating various problems associated with known wireless communication units provided these principles or equivalents thereof are employed.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, upper and lower and the like are used solely to distinguish one from another entity or action without necessarily requiring or implying any actual such relationship or order between such entities or actions.

The terms “a” or “an” as used herein are defined as one or more than one. The term “plurality” as used herein is defined as two or more than two. The term “another” as used herein is defined as at least a second or more. The terms “including,” “having” and “has” as used herein are defined as comprising (i.e., open language). The term “coupled” as used herein is defined as connected, although not necessarily directly and not necessarily mechanically.

Much of the inventive functionality and many of the inventive principles are best implemented with or in software programs or instructions and integrated circuits (ICs) such as general purpose processors and application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

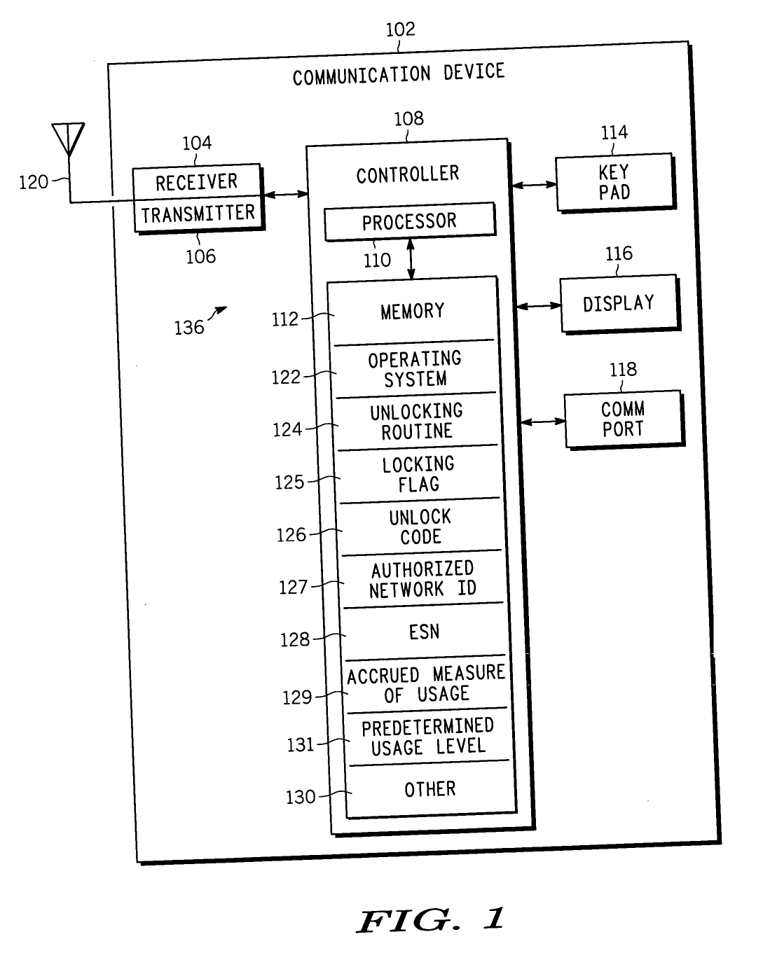

Basically, as shown in FIG. 1, a first embodiment of the present disclosure concerns a wireless communication unit 102, which includes, among other unillustrated parts, a receiver 104, a transmitter 106, an antenna 120, a system 136 for unlocking the wireless communication unit, a controller 108 including a processor 110 inter coupled to a memory 112, a keypad 114, a display 116, and a communication port 118. The transmitter 106, the receiver 104, the keypad 114, the display 116, and the communication port 118 are functionally coupled to the controller 108 as depicted. The communication port 118 may be used, for example, to couple to accessories, such as cameras and the like or to load or provide programs and data to the controller for use thereby or storage in the memory 112.

The memory 112 preferably has at least some non-volatile memory, such as EEPROM or flash memory so that data and programs are retained even when a battery (not shown) of the wireless communication unit 102 is removed, as well as conventional RAM, etc. The memory 112 stores an operating system 122 that when executed by the processor 110 control operation of the wireless communication unit 102, several items further and specifically described below and other programs and data 130 for operating the wireless communication unit 102. The receiver and the transmitter communicate with a radio access network in a conventional manner through the antenna 120. The double-headed arrows in FIG. 1 indicate a functional coupling between the controller 108 and the various components.

In this document, the word “locking” refers to a restriction placed on a wireless communication unit 102, specifically functionality of the communications unit. This locking or restriction is intended to encourage utilization of the network or services provided by the service provider that originally subsidized the initial acquisition costs of a communications unit. Typically this subsidy is in the form of a price reduction for the communications unit. Locking, by encouraging use of the services from the service provider primarily guarantees or insures that the service provider is able to recover the subsidy on the communications unit or that the subsidy is returned to the service provider in the form of tariffs or charges for using the services. Such locking, which is sometimes referred to as “network locking” or “simlocking” is well known in the art. For example, the wireless communication unit 102 can be “locked,” such that the wireless communication unit 102 can only be used or used to its full potential functionality with a selected network, a selected network operator, a particular wireless reseller, or a particular SIM (subscriber identification module).

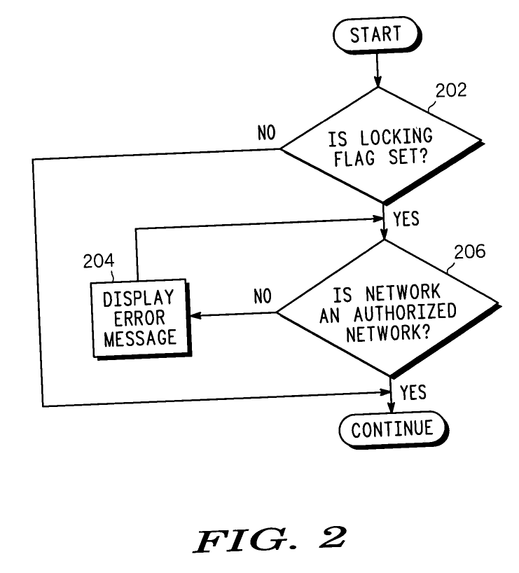

One way of locking a wireless communication unit 102 to a selected network, or service provider, is illustrated in FIG. 2. FIG. 2 shows a process that is run by or controlled from the operating system 122. In a locking flag decision 202, it is determined whether a locking flag 125 is set. The locking flag 125 may be, for example, a bit stored in the memory 112. If the locking flag 125 is set, then the wireless communication unit 102 is locked to a selected network, or a selected service provider, and if the locking flag 125 is not set, then the wireless communication unit 102 may be used with any service provider, as long as the service provider grants permission. As shown in FIG. 2, if the locking flag 125 is set, it is determined whether the current network service provider is the selected service provider; that is, whether the current network is an authorized network. This may be done, for example, by comparing a network ID code, which identifies the current network service provider from information received through the receiver 104 when, for example, the wireless communication unit is turned on, with an authorized network identification code 127 stored securely in the memory 112. If there is a match, then the operating system 122 continues, and if there is not a match, then, optionally, an error or the like message is displayed at 204, and in any event the operating system 122 limits the functionality of the wireless communication unit 102 so that, for example, only 911 or emergency calls can be made. For security purposes, the authorized network identification code 127 may be encoded or securely stored in the memory 112 such that a user is incapable of modifying it without destroying or disabling the wireless communication unit 102.

Although FIG. 2 illustrates or suggests an endless loop or a discontinuation of the operating system processes (until an authorized network is found) as a way of locking the wireless communication unit 102, the wireless communication unit 102 may be locked in any way that precludes or disables unauthorized communications such as by disabling RF circuitry, limiting power-on time for the wireless communication unit 102 or the processor 110 or by other similar methods.

Some wireless communication units include a removable subscriber identification module, or SIM, which is well understood in the art. Determining whether a current network service provider is authorized at 206 may involve comparing a network code stored in an installed SIM (not shown) with the authorized network identification code 127, which is stored securely in the memory 112. The SIM serves as another memory, which is functionally coupled to the processor 110 when installed. If the processor 110 detects a match (e.g. authorized network), then the outcome of the decision at 206 is positive, and the operating system 122 is allowed to or will continue to handle calls.

Thus, the wireless communication unit 102 may have a lower functionality level and a higher functionality level, and the communication unit is limited to the lower functionality level when the unit is locked and used with an unauthorized service provider. The wireless communication unit 102 operates at the higher functionality level thus permitting calls to be made and received freely as long as the selected network service provider or an authorized service provider is providing service. At the higher functionality level, the wireless communication unit 102 permits calls to be made and received freely, regardless of the network service provider being used, assuming the network service provider grants permission. However the higher functionality level is only available when the unit is unlocked or when the unit is locked and the selected or an authorized service provider is being used for service. The display of the error message at 204 occurs in the lower functionality level in FIG. 2 when the current network service provider is unauthorized.

In the lower functionality level, the wireless communication unit 102 may permit, for example, only emergency calls or emergency calls and calls that get the selected service provider involved in a revenue generating manner, such as calls to another wireless communications unit within the selected service providers coverage area. Note that while these discussions refer to a higher and a lower functionality level, there can be a multiplicity of functionality levels. For example, the selected service provider or service provider that subsidized the original communications unit acquisition may have revenue sharing agreements with other service providers, such as neighboring service providers. In these situations it can be desirable for the neighboring service providers to be considered authorized or partially authorized service providers.

In these instances where economic benefit to the selected service provider is evident, the communications unit would be unlocked for the functionality needed to take advantage of services provided by service providers having such agreements with the selected service provider at least to the extent of the services covered by such agreements. For instance the revenue sharing agreement with some service providers may cover voice services but not data services, such as short messaging services in which case the lower level or another intermediate level of functionality would allow voice call origination or termination but not short messaging services. One can anticipate other agreements with local area network service providers and varying levels of functionality that may be allowed for communications units enabled to take advantage of such networks. One of ordinary skill given the above exemplary discussion will recognize that multiple levels of functionality, multiple degrees of authorization for different service providers, and thus multiple locking states can be useful.

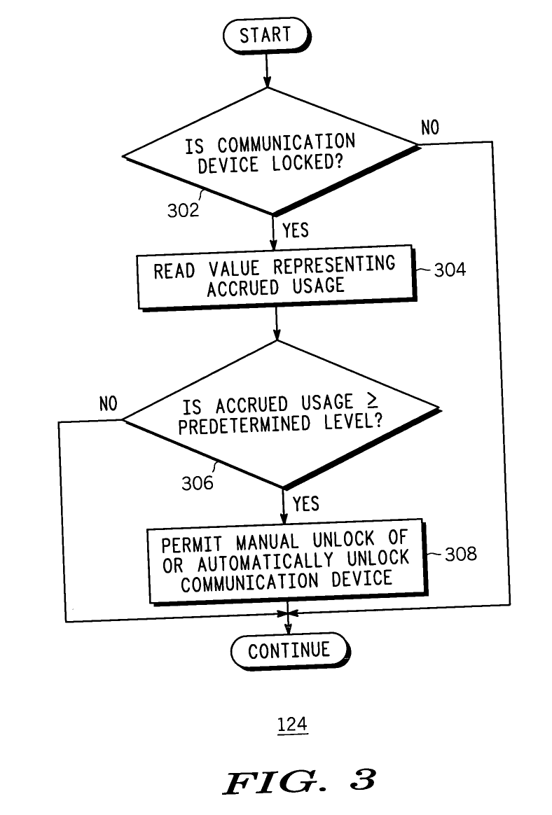

The processor 110 serves as or performs as a locking device or locking function that permits the wireless communication unit 102 to be unlocked such that the wireless communication unit 102 is no longer limited to the lower functionality level, even when used with an unauthorized network service provider, when an accrued measure of usage of the wireless communication unit 102 reaches a predetermined level, as discussed below with respect to FIG. 3.

An exemplary wireless communication unit 102 of the present invention is locked, or “network locked,” until the wireless communication unit 102 is unlocked. The memory 112 may store an identifier such as an electronic serial number (ESN) 128 unique to the wireless communication unit 102. Alternatively, the identifier, such as the electronic serial number 128, may not be stored in the memory 112 but may be otherwise associated with the wireless communication unit 102. The memory 112 may be used for storing an unlock code 126 specific to the wireless communication unit 102. The unlock code 126 may be used in changing the wireless communication unit 102 from being locked to being unlocked. The unlock code 126 may be generated by the processor 110 when needed. Alternatively, the unlock code 126 may be generated by a device (unillustrated) other than the wireless communication unit 102, and the device may load the unlock code 126 into the memory 112 through the communication port 118. The unlock code 126 may be generated by an algorithm using the electronic serial number 128 and a secret or secure code.

When the unlock code is generated as needed, the wireless communication unit 102 may store the algorithm and the secret code in the memory 112, and a subroutine can be executed in the processor 110 to generate the unlock code 126 using the electronic serial number 128 and the algorithm. The unlock code 126 is secure or cannot be produced or reproduced without knowledge of the secret code and the algorithm. The unlock code 126 and the algorithm may be securely stored in the memory 112 so that they are inaccessible to unauthorized persons.

FIG. 3 shows an unlocking subroutine 124, or a process for automatically unlocking or permitting unlocking, such as manual unlocking by an operator of the wireless communication unit 102. The subroutine of FIG. 3 can be run periodically by the operating system 122 of the wireless communication unit 102. At 302, the processor 110 queries whether the wireless communication unit 102 is locked by, for example, determining whether the locking flag 125 is set. As indicated in FIG. 3, if the wireless communication unit 102 is locked, at 304 a value representing or corresponding to an accrued measure of usage 129 is read from the memory 112.

The measure of usage is preferably a value that represents or corresponds to a revenue generating state of the wireless communication unit 102. For example, the measure of usage may be a value representing time during which the wireless communication unit has been used in a revenue-generating mode. Alternatively, the measure of usage may be a value representing money paid or owed by the subscriber to the authorized network service provider. Further, the measure of usage may be a value representing the time during which the transmitter 106 is energized. Other similar values that represent usage of the wireless communication unit 102 or the network may be used, provided they are available to or can be determined by the processor 110. The processor 110 periodically updates the accrued measure of usage 129 in the memory 112. For security purposes, the accrued measure of usage 129 is preferably stored securely and is inaccessible to unauthorized persons using well known security measures. Similarly, subroutines of the operating system 122 that determine the accrued measure of usage 129 (not illustrated) are securely stored and are inaccessible to unauthorized persons.

If the wireless communication unit 102 is not locked at the query 302, no reading of the accrued measure of usage 129 takes place, as shown, and the determination of whether to unlock the wireless communication unit 102 is bypassed. If the outcome of the query 302 is negative, the wireless communication unit 102 is operating at the higher functionality level.

Further in FIG. 3, after the value representing usage has been read, it is determined whether the accrued measure of usage 129 is greater than or equal to a predetermined usage level 131. The predetermined usage level 131 may be, for example, a level at which the subsidy or similar cost has been recovered by the service provider. The predetermined usage level 131 may be pre-stored in the memory 112 in a secure manner. For example, the predetermined usage level 131 may be stored through the communication port 118 during an initialization procedure performed by the selected service provider before the wireless communication unit 102 is delivered to a customer. If the accrued measure of usage 129 equals or exceeds the predetermined level of usage 131, the processor 110 either proceeds to unlock the phone automatically or it gives permission for the user to manually unlock the wireless communication unit 102. The processor 110 may give permission for manual unlocking to take place by, for example, setting an unlocking permission flag that is stored in the memory 112 and displaying a prompt on the display 116.

If the accrued measure of usage 129 is less than the predetermined usage level 131, no unlocking takes place and no permission for manual unlocking is given, as shown, and the operating system 122 continues. In other words, if the outcome is negative in the query 306, the wireless communication unit 102 continues to operate at the lower functionality level, unless the unit is operating on an appropriate authorized or selected service provider. That is, as long as the selected network service provider is providing service, the wireless communication unit 102 can freely make and receive calls.

If the wireless communication unit 102 is unlocked automatically at 308, the processor 110 unsets the locking flag 125. If, instead, permission is given to unlock the wireless communication unit 102 manually at 308, then, for example, a menu option may be enabled that allows the user to easily unlock the wireless communication unit 102 with the keypad 114. That is, the menu option for unlocking the wireless communication unit 102 is available for display on the display 116. Manual unlocking may involve entering a code using the keypad 114. If the processor 110 determines that the entered code matches a securely stored unlock code 126, the locking flag 125 is unset or reset.

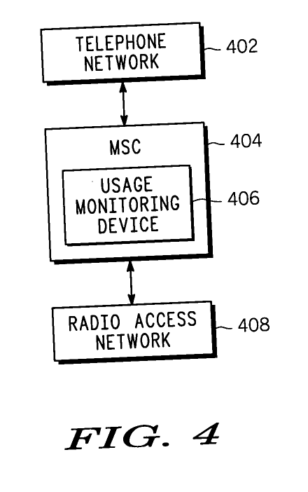

FIG. 4 shows the structure of a second embodiment. The wireless communication unit 102 of FIG. 1 also is used in the second embodiment in cooperation with the apparatus of FIG. 4, however, the process performed by the processor 110 and the items stored in the memory 112 may differ. In the second embodiment, the measuring and accrual of a value representing usage of the wireless communication unit 102 is performed by a usage monitoring device 406, which is located in the network infrastructure. Unlocking the wireless communication unit 102 is performed by communicating with the wireless communication unit 102 through a radio access network 408.

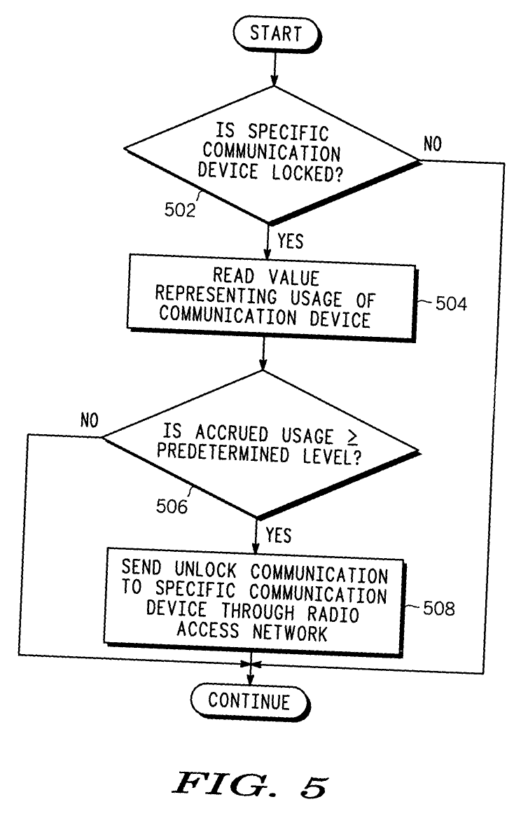

FIG. 4 shows a telephone network 402, which includes wired telephones. The telephone network 402 is coupled to a MSC (mobile switching center) 404. The MSC is coupled to a radio access network, which includes base stations for communication with mobile units such as the wireless communication unit 102. The MSC includes or is coupled to the usage monitoring device 406. The usage monitoring device 406 is preferably a computer and may be a computer that normally performs customer billing for the service provider or operator of the radio access network 408. Note that FIG. 4 shows the basic elements of a network or system that is owned and operated by a service provider. Other service providers may have other networks or systems or infrastructure that is similar to that depicted in FIG. 4. Different resellers of services may use the same infrastructure. Normally only the selected service provider or subsidizing service provider operating in accordance with this embodiment will need the usage monitoring device or function 406 FIG. 5 is an exemplary process performed periodically by the usage monitoring device 406 of the second embodiment. At 502, the usage monitoring device 406 determines whether a specific wireless communication unit 102 is network locked. If the specific wireless communication unit 102 is locked, operations labeled 504, 506 and 508 are performed. These operations correspond to and are similar to operations 304, 306, and 308 of FIG. 3. That is, the usage monitoring device 406 reads a value representing usage of the specific wireless communication unit 102 from a memory of the usage monitoring device or a memory coupled to the usage monitoring device. As stated previously, the value may be any of several values representing a revenue generating state of the wireless communication unit 102, such as the time during which the transmitter 106 is activated or a value representing charges billed to the customer using the specific wireless communication unit 102. If the accrued usage of the specific wireless communication unit 102 equals or exceeds a predetermined level at 506, the usage monitoring device 406 sends an unlock communication at 508 to the specific wireless communication unit 102 through the radio access network 408. The unlock communication may be an encrypted communication that includes or corresponds to the unlock code 126, which has been previously stored in the memory 112. As is well understood in the art, the unlock code 126 may be generated by the ESN 128 of the wireless communication unit 102 and an algorithm or by other conventional security measures. The unlock code 126 may be stored by the usage monitoring device 406 or it may be generated as needed by the usage monitoring device 406 using the algorithm and the ESN 128.

If the specific wireless communication unit 102 is not locked at 502, then the process of FIG. 5 bypasses the operations labeled 504, 506 and 508, as shown. The determination of whether the specific device is unlocked is determined, for example, by checking the state of a locking flag 125 stored in or available to the usage monitoring device 406 in association with the specific wireless communication unit 102. Alternatively, the usage monitoring device 406 can query the specific wireless communication unit 102 to determine the state of the locking flag 125 stored the memory 112.

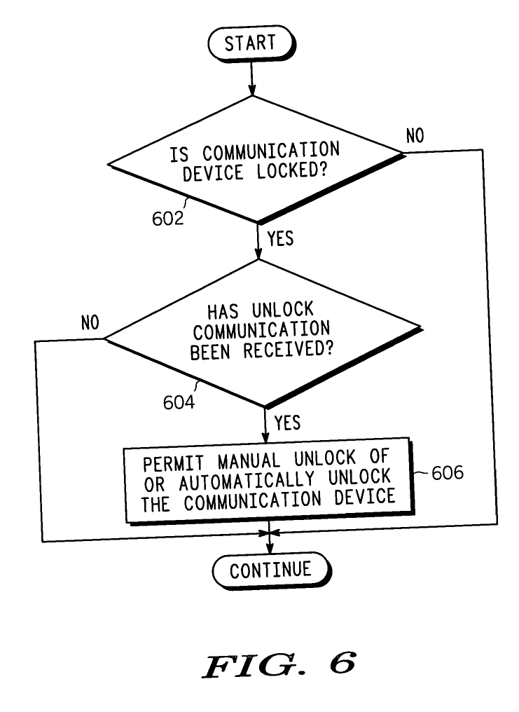

FIG. 6 shows an exemplary process that is performed periodically by the operating system 122 of the wireless communication unit 102 of the second embodiment. At 602, the processor 110 determines whether the wireless communication unit 102 is locked. If the wireless communication unit 102 is locked, it is determined at 604 whether an unlock communication has been received through the antenna 120 and the receiver 104 through the radio access network 408 from the usage monitoring device 406. If the unlock communication has been received, the wireless communication unit 102 either automatically unlocks the wireless communication unit 102 or sets a permission flag at 606, which permits the wireless communication unit 102 to be manually unlocked in the manner described above in the description of the first embodiment.

The apparatus and methods discussed above and the inventive principles thereof are intended to and can alleviate problems with conventional wireless communication units. Using these principles of network unlocking will contribute to user satisfaction. It is expected that one of ordinary skill given the above described principles, concepts and examples will be able to implement other alternative procedures and constructions that offer the same benefits. It is anticipated that the claims below cover many such other examples. For example, in the second embodiment, it is stated that the usage monitoring device monitors usage of the wireless communication unit 102. However, the usage monitoring device 406 may read the accrued measure of usage 129 from the memory 112 of the wireless communication unit 102. That is, in the second embodiment, usage may be determined by the usage monitoring device or by reading or retrieving data from the wireless communication device 102 through the radio access network 408. Also, in the description of the first embodiment, it said that various items are loaded into the memory through the communication port 118. However, the items stored in the memory 112 can be loaded through a wireless data transmission instead.

The disclosure is intended to explain how to fashion and use various embodiments in accordance with the invention rather than to limit the true, intended and fair scope and spirit thereof. The forgoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A wireless communication unit comprising:
a locking function that locks the wireless communication unit such that the wireless communication unit operates at a higher functionality level when used with a first service provider and a lower functionality level when used with a second service provider;
wherein, when an accrued measure of usage of the wireless communication unit reaches a predetermined level, the locking function further performs one of;
unlocking the wireless communication unit and permitting the wireless communication unit to be unlocked such that the wireless communication unit is no longer limited to the lower functionality level when used with the second service provider.

2. A wireless communication unit according to claim 1, wherein the locking function includes a processor, which executes a process for accruing the accrued measure of usage.

3. A wireless communication unit according to claim 1, wherein the locking function includes a processor, which executes a process for accruing the accrued measure of usage and for automatically unlocking the wireless communication unit when the accrued measure of usage reaches the predetermined level.

4. A wireless communication unit according to claim 1, wherein the locking function includes a processor, which executes a process for automatically unlocking the wireless communication unit when the wireless communication unit receives an unlock communication from the first service provider.

5. A wireless communication unit according to claim 1, wherein the locking function includes a processor, which executes a process for permitting the wireless communication unit to be manually unlocked when the wireless communication unit receives an unlock communication from the first service provider.

6. A wireless communication unit according to claim 1, wherein the measure of usage is a value corresponding to time during which the wireless communication unit has been used in a revenue-generating mode.

7. A wireless communication unit according to claim 1, wherein the measure of usage is a value corresponding to money paid by the subscriber to the first service provider.

8. A wireless communication unit according to claim 1, wherein the measure of usage is a value corresponding to revenue produced by the wireless communication unit for the first service provider.

9. A wireless communication unit according to claim 1, wherein the wireless communication unit includes a transmitter and the measure of usage is a value corresponding to time during which the transmitter is energized.

10. A method of regulating usage of a wireless communication unit, the method comprising:
locking the wireless communication unit such that the wireless communication unit operates in a first mode when used with a first service provider and in a second mode when used with a second service provider, wherein the second mode has a lower level of functionality that the first mode; and
performing one of the following when an accrued measure of usage of the wireless communication unit reaches a predetermined level,
unlocking the wireless communication unit and permitting the wireless communication unit to be unlocked, such that the wireless communication unit is not limited to the second mode when used with the second service provider.

11. A method according to claim 10, wherein the method includes:
determining the accrued measure of usage in the wireless communication unit; and
automatically unlocking the wireless communication unit when the accrued measure of usage reaches the predetermined level.

12. A method according to claim 10, wherein the method includes:
determining the measure of usage in the wireless communication unit; and
permitting the wireless communication unit to be manually unlocked when the accrued measure of usage reaches the predetermined level.

13. A method according to claim 10, wherein the method includes:
determining the accrued measure of usage in the wireless communication unit; and
storing a value representing the accrued usage in the wireless communication unit.

14. A method according to claim 10, wherein the method includes:
wirelessly receiving an unlock communication after the accrued measure of usage reaches the predetermined level; and
permitting the wireless communication unit to be manually unlocked when the unlock communication is received.

15. A method according to claim 10, wherein the method includes:
wirelessly receiving an unlock communication after the accrued measure of usage reaches the predetermined level; and
automatically unlocking the wireless communication unit when the unlock communication is received.

16. A method according to claim 10, further including determining the accrued measure of usage as a value corresponding to time during which the wireless communication unit has been used in a revenue-generating mode.

17. A method according to claim 10, further including determining the accrued measure of usage as a value corresponding to money paid by the subscriber to the first service provider.

18. A method according to claim 10, further including determining the accrued measure of usage as a value corresponding to time during which a transmitter in the wireless communication unit is energized.

19. A system for unlocking a wireless communication unit, the system comprising:
a locking function that measures usage of the wireless communication unit and locks the wireless communication unit such that the wireless communication unit operates at a higher functionality level when used with a first service provider and a lower functionality level when used with a second service provider,
wherein the locking function performs one of the following functions when an accrued measure of usage of the wireless communication unit has reached a predetermined level:
unlocks the wireless communication unit: and
permits the wireless communication unit to be unlocked, such that the wireless communication unit is no longer limited to the lower functionality level when used with the second service provider.

20. A system according to claim 19, wherein the measure of usage is a value representing time during which the wireless communication unit has been used in a revenue-generating mode.

21. A method of controlling functionality of a wireless communication unit, the method comprising:
monitoring usage of a wireless communication unit that has a restriction limiting the wireless communication to a first service provider;
storing a measure of usage of the wireless communication unit; and
sending, when the measure of usage reaches a predetermined level, an unlock communication to the wireless communication unit, wherein the unlock communication facilitates one of removing the restriction and permitting the restriction to be removed.

22. A method according to claim 21, wherein the monitoring usage further comprises accruing the measure of usage as a value corresponding to time during which the wireless communication unit has been used in a revenue-generating mode.

23. A method according to claim 21, wherein the monitoring usage further comprises accruing the measure of usage as a value corresponding to money paid by a subscriber to the selected service provider.
